(19) United States
(12) Patent Application Publication
(10) Pub. No.: US 2026/0060334 A1
(43) Pub. Date: Mar. 5, 2026

(54) HEAT-NOT-BURN DEVICE AND HEATING CONTROL METHOD THEREFOR

(71) Applicant: SMOORE INTERNATIONAL HOLDINGS LIMITED, George Town (KY)

(72) Inventors: Xingfu ZHANG, Shenzhen (CN); Hengheng DOU, Shenzhen (CN); Hongming ZHOU, Shenzhen (CN); Rihong LI, Shenzhen (CN); Pengfei HUANG, Shenzhen (CN); Zi GAO, Shenzhen (CN)

(21) Appl. No.: 19/383,510

(22) Filed: Nov. 7, 2025

Related U.S. Application Data
(63) Continuation of application No. PCT/CN2024/091489, filed on May 7, 2024.

(30) Foreign Application Priority Data
May 9, 2023 (CN) 202310520712.5

(51) Int. Cl. A24F 40/57; A24F 40/20; A24F 40/465; A24F 40/53

(52) U.S. Cl. CPC A24F 40/57; A24F 40/465; A24F 40/53; A24F 40/20

(57) ABSTRACT

A heating control method for a heat-not-burn device having a heating component and a power supply for supplying power to the heating component includes: heating, by the power supply, the heating component at a first power within a preset time for starting heating; and after the preset time, controlling the power supplying of the heating component so as to cause a temperature of the heating component to vary based on a preset temperature curve.

### CROSS-REFERENCE TO PRIOR APPLICATION

This application is a continuation of International Patent Application No. PCT/CN2024/091489, filed on May 7, 2024, which claims priority to Chinese Patent Application No. 202310520712.5, filed on May 9, 2023. The entire disclosure of both applications is hereby incorporated by reference herein.

### FIELD

The present disclosure relates to the field of atomization, and in particular, to a heat-not-burn device and a heating control method therefor.

### BACKGROUND

In a heat-not-burn device, due to the limitations of a heating control manner, the preheating time for an aerosol generating substrate is long. From the time a user starts heating to the end of preheating, it usually takes more than 30 seconds to prompt the user to inhale. As a result, the user experience is poor.

### SUMMARY

In an embodiment, the present invention provides a heating control method for a heat-not-burn device having a heating component and a power supply for supplying power to the heating component, the heating control method comprising: heating, by the power supply, the heating component at a first power within a preset time for starting heating; and after the preset time, controlling the power supplying of the heating component so as to cause a temperature of the heating component to vary based on a preset temperature curve.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a flowchart of an embodiment of a heating control method for a heat-not-burn device according to the present disclosure;

FIG. 2 is a schematic diagram of a preset temperature curve of an embodiment of a heating control method for a heat-not-burn device according to the present disclosure;

FIG. 3 is a schematic diagram of a preset temperature curve of another embodiment of a heating control method for a heat-not-burn device according to the present disclosure;

FIG. 4 is a schematic diagram of a preset temperature curve of still another embodiment of a heating control method for a heat-not-burn device according to the present disclosure;

FIG. 5 is a schematic structural diagram of a heating component in an embodiment of a heat-not-burn device according to the present disclosure; and

FIG. 6a and FIG. 6b are schematic structural diagrams of a heating component in an embodiment of a heat-not-burn device according to the present disclosure.

### DETAILED DESCRIPTION

In an embodiment, the present invention provides a heat-not-burn device and a heating control method therefor, to overcome the technical defect in the existing art that time a user waits for inhalation is long.

In an embodiment, the present invention provides a heating control method for a heat-not-burn device. The heat-not-burn device includes a heating component and a power supply for supplying power to the heating component.

The heating control method includes:
heating, by the power supply, the heating component at first power within preset time for starting heating; and
after the preset time, controlling the power supplying of the heating component to cause the temperature of the heating component to vary based on a preset temperature curve.

Further, in the heating control method for the heat-not-burn device of the present disclosure, the heating control method further includes:
sending a prompt signal at the preset time or within a preset range from the preset time, where the prompt signal is configured for prompting a user to inhale.

Further, in the heating control method for the heat-not-burn device of the present disclosure, the preset temperature curve includes a first stage of increasing an initial temperature to a first temperature, a second stage of decreasing the first temperature to a second temperature, a third stage of maintaining the second temperature, and a fourth stage of increasing the second temperature.

Further, in the heating control method for the heat-not-burn device of the present disclosure, the preset temperature curve includes a first stage of increasing an initial temperature to a first temperature and a second stage of decreasing the first temperature to a second temperature and maintaining the second temperature.

Further, in the heating control method for the heat-not-burn device of the present disclosure, the preset temperature curve includes a first stage of increasing an initial temperature to a first temperature, a second stage of decreasing the first temperature to a second temperature, and a third stage of being not greater than the second temperature.

Further, in the heating control method for the heat-not-burn device of the present disclosure, any heating manner such as resistance heating, electromagnetic heating, or infrared heating is used to control the heating component.

Further, in the heating control method for the heat-not-burn device of the present disclosure, the infrared heating is light-wave infrared heating.

Further, in the heating control method for the heat-not-burn device of the present disclosure, the heating component includes:
a heating element; and
a housing. The heating element and the wall portion of the housing are at least partially spaced apart; the surface of the heating element is covered with an infrared radiation layer; the heating element is powered on to excite the infrared radiation layer to radiate infrared light waves; and the wall portion of the housing allows the infrared light waves to pass through.

Further, in the heating control method for the heat-not-burn device of the present disclosure, the heating element is arranged in the housing in a spacing manner, and the housing is at least partially inserted into an aerosol generating substrate.

Further, in the heating control method for the heat-not-burn device of the present disclosure, the housing includes a first tube body and a second tube body sleeving the periphery of the first tube body.

A gap is reserved between the first tube body and the second tube body, and the gap forms a first accommodating cavity for accommodating the heating element.

The heating element is arranged at the periphery of the first tube body and is spaced apart from the outer wall of the first tube body; and a second accommodating cavity for heating an aerosol generating substrate is formed on the inner side of the first tube body.

Further, in the heating control method for the heat-not-burn device of the present disclosure, the first power is the maximum power that is provided by the power supply to the heating component, or the first power is within a preset range of the maximum power.

Further, in the heating control method for the heat-not-burn device of the present disclosure, the first power is the maximum power that is provided to the heating component under a condition that the voltage of the power supply is a preset voltage, and the preset voltage is a minimum voltage corresponding to an ability of the heat-not-burn device for heating one unit of aerosol generating substrate.

Further, in the heating control method for the heat-not-burn device of the present disclosure, within the preset time for starting the heating, the power supplying of the heating component is controlled by using a first proportion-integration-differentiation (PID) control algorithm, to cause the power supply to heat the heating component at the first power.

In the first PID control algorithm, a deviation value is processed based on a first function to obtain a proportional product factor; the deviation value is a difference between the target temperature of the heating component and a current temperature; the first function is a monotonically increasing function; and a slope of the first function increases as the deviation value increases.

Further, in the heating control method for the heat-not-burn device of the present disclosure, the first function is one of a cubic function, an exponential function, or a product of the deviation value and the absolute value of the deviation value.

Further, in the heating control method for the heat-not-burn device of the present disclosure, after the preset time, the power supplying of the heating component is controlled by using the first PID control algorithm, to cause the temperature of the heating component to vary based on the preset temperature curve.

Further, in the heating control method for the heat-not-burn device of the present disclosure, within the preset time for starting the heating, the power supply heats the heating component at the first power.

After the preset time, the power supplying of the heating component is controlled by using a second PID control algorithm; and the second PID control algorithm is an incremental PID control algorithm.

Further, in the heating control method for the heat-not-burn device of the present disclosure, an initial value of an output value in the second PID control algorithm is an output preset value; and the output preset value is a maximum value that can be set within second preset time while not exceeding the target temperature.

Further, in the heating control method for the heat-not-burn device of the present disclosure, within the preset time for starting the heating, the power supplying of the heating component is controlled by using a third PID control algorithm, to cause the power supply to heat the heating component at the first power; and in the third PID control algorithm, a target temperature is set based on the power supplied to the heating component reaching the first power within the preset time.

Further, in the heating control method for the heat-not-burn device of the present disclosure, after the preset time, the power supplying of the heating component is controlled by using the third PID control algorithm, to cause the temperature of the heating component to vary based on the preset temperature curve; and the target temperature of the heating component in the third PID control algorithm is a temperature corresponding to a current moment in the preset temperature curve.

In addition, the present disclosure further provides a heat-not-burn device, including a heating component, a power supply for supplying power to the heating component, a processor, and a memory having a computer program stored therein. The processor, when executing the computer program, implements the steps of the above heating control method for the heat-not-burn device.

By implementing the technical solution of the present disclosure and controlling the heating component, within the preset time for starting the heating, the power supply heats the heating component at the first power. After the preset time, the power supplying of the heating component is controlled, so that the temperature of the heating component varies based on the preset temperature curve. Due to the existing heating control scheme for the heat-not-burn device, the temperature of the heating component is controlled based on the preset temperature curve throughout the entire heating control process. To maintain the temperature of the heating component to be close to a target temperature curve throughout the entire heating process, the preheating time is long. In the embodiments of the present disclosure, the heating component is heated at the first power within the preset time. Within the preset time, the first power is not constrained by the target temperature curve; average power that is higher than power provided by the existing heat-not-burn device can be achieved in the preheating stage; and the preheating time is effectively shortened.

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the disclosed embodiments without creative efforts shall fall within the protection scope of the present disclosure.

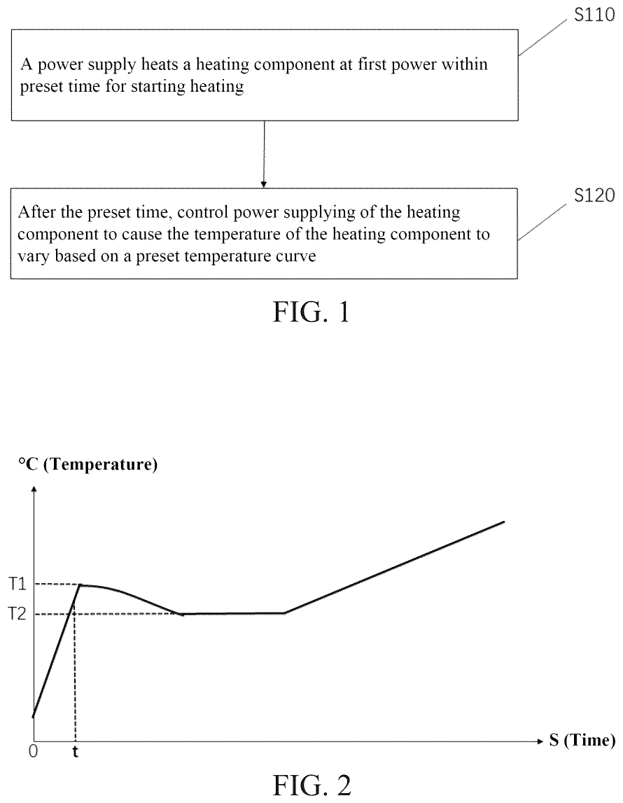

FIG. 1 is a flowchart of an embodiment of a heating control method for a heat-not-burn device according to the present disclosure. The heat-not-burn device includes a heating component and a power supply for supplying power to the heating component.

In step S110, the power supply heats the heating component at first power within preset time for starting heating.

In some embodiments, the first power P is maximum power P that can be provided by the power supply to the heating component. The first power is

$$P = \frac{{U}_{t}^{2}}{{R}_{t}} ,$$

where Uₜ is a voltage applied by the power supply to the heating component, and Rt is the current resistance of the heating component. It should be noted that Uₜ gradually decreases in the process of heating the heating component. The current resistance Rt of the heating component may alternatively change as the temperature increases. Correspondingly, the magnitude of the first power may change, but the first power is always the maximum power that can be provided by the power supply to the heating components. It can be understood that a person skilled in the art that using the maximum power to heat the heating component within the preset time can cause the heating component to be heated up quickly, thereby shortening the heating time to the greatest extent. Certainly, the heating component is heated within a preset range of the maximum power, for example, by using 90%, 80%, and 70% of the maximum power as the first power. The heating effect is not better than the heating effect achieved at the maximum power, but the heating time can be shortened to an extent.

In some embodiments, the heating control method further includes a step of sending a prompt signal at the preset time to prompt a user to inhale. In some embodiments, the user can be prompted to inhale slightly earlier than the preset time, or slightly later than the preset time. That is, within a preset range of the preset time, the user can be prompted to inhale. The prompt signal is not limited to vibration, flashing of an indicator light, a voice, and other prompt manners.

In step S120, after the preset time, the power supplying of the heating component is controlled to cause the temperature of the heating component to vary based on a preset temperature curve.

Due to the existing heating control scheme for the heat-not-burn device, the temperature of the heating component is controlled based on the preset temperature curve throughout the entire heating control process. After the temperature of the heating component reaches a preset inhalation temperature, the user is prompted to inhale. To maintain the temperature of the heating component to be close to a target temperature curve throughout the heating process and avoid an overshooting phenomenon (i.e. the temperature of an aerosol generating substrate is greater than a target temperature), within a preheating time period, an existing PID control algorithm or another temperature control manner has long preheating time for the heating component in an actual process.

The inventor has found that if the target temperature curve is not introduced within a preset time range, a control module controls the power supply to provide power to the heating component at the first power (the first power can be the maximum power that can be provided by the power supply, or slightly less than the maximum power that can be provided by the power supply, such as between 70% and 100% of the maximum power, or equal to the maximum power that can be provided by the power supply to the heating component at a preset voltage), and inhalation is carried out immediately at the preset time. A concentration of a first puff of aerosol will not be significantly insufficient, and a user experience is enhanced. After the preset time, the target temperature curve is introduced for temperature control to maintain the consistency of aerosols generated by the aerosol generating substrate.

In this embodiment of the present disclosure, the heating component is heated at the first power within the preset time. The power supplying is performed at the first power within the preset time, without performing power adjustment along with the target temperature curve. Average power that is higher than power provided by the existing heat-not-burn device can be achieved in a preheating stage, and the preheating time is effectively shortened.

In some embodiments, the heat-not-burn device provides a first inhalation mode and a second inhalation mode for selection by a user. In the first inhalation mode, the heating control method includes: within the preset time for starting the heating, heating, by the power supply, the heating component at the first power; and after the preset time, controlling the power supplying of the heating component to cause the temperature of the heating component to vary based on the preset temperature curve. In the second inhalation mode, the heating control method includes: upon receiving a heating start signal, controlling the power supplying of the heating component to cause the temperature of the heating component to vary based on the preset temperature curve. In some cases, some users prefer to use the heat-not-burn device in a more timely manner, or in some cases, some users are more accustomed to using a conventional heat-not-burn device.

As shown in FIG. 2, in some embodiments, the preset temperature curve includes a first stage of increasing an initial temperature to a first temperature T1, a second stage of decreasing the first temperature T1 to a second temperature T2, a third stage of maintaining the second temperature T2, and a fourth stage of increasing the second temperature T2.

The origin (point 0) of the preset temperature curve is time when the heating start signal is received. If current time t1 is less than the preset time t, the target temperature value of the preset temperature curve may not affect the power of the heating component, and the power is supplied to the heating component at the first power. If the current time t1 is greater than the preset time t, a target temperature is obtained from the preset temperature curve, a target temperature value corresponding to the current time t1 is read, and the power supplying of the heating component is controlled based on the target temperature value, so that the temperature of the heating component changes based on the preset temperature curve.

Optionally, since the power supplying is performed on the heating component at the first power within the preset time t, the preset temperature curve is not considered at this time. Therefore, the origin (point 0) of the preset temperature curve may alternatively be set as the preset time t. That is, the preset time t is used as the origin (point 0) of the preset temperature curve. Correspondingly, a preset temperature curve after the origin (point 0) is adjusted may be adaptively adjusted based on the curve in FIG. 2. This will not be elaborated here.

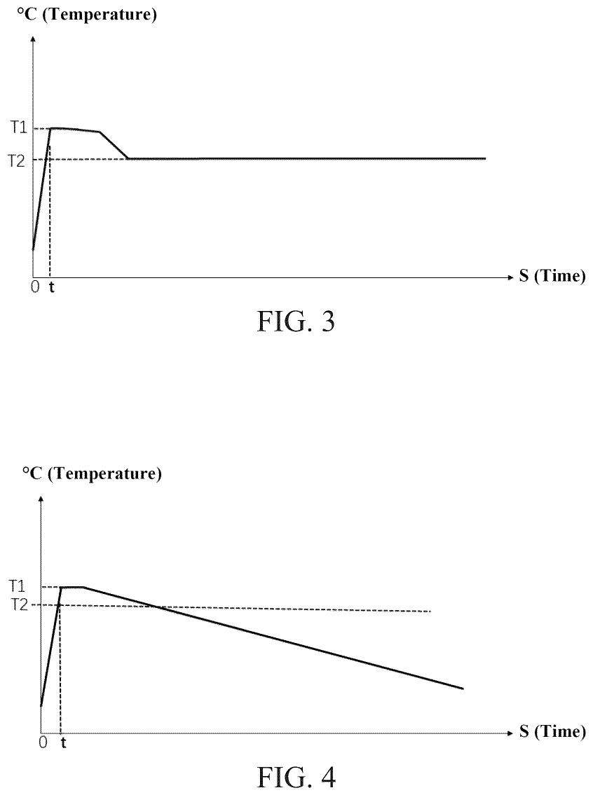

As shown in FIG. 3, the preset temperature curve includes a first stage of increasing an initial temperature to a first temperature T1, a second stage of decreasing the first temperature T1 to a second temperature T2, and a third stage of maintaining the second temperature T2, where t is the preset time.

The preset temperature curve mainly depends on an aerosol generating substrate. The aerosol generating substrate releases some volatile compounds at different temperatures. Some of the volatile compounds released by the aerosol generating substrate are only formed through heating process. Each volatile compound is released at a specific release temperature or above. By controlling a maximum operating temperature below the release temperatures of some volatile compounds, the release or formation of these components can be avoided.

As shown in FIG. 4, in other embodiments, the preset temperature curve includes a first stage of increasing an initial temperature to a first temperature T1, a second stage of decreasing the first temperature T1 to a second temperature T2, and a third stage of being not greater than the second temperature T2. Where t is the preset time.

It should be noted that there are various implementation manners for decreasing the first temperature T1 to the second temperature T2, including: maintaining the first temperature T1 for a period of time and then decreasing the first temperature T1 to the second temperature T2, or gradually decreasing the first temperature T1 to the second temperature T2. This is not limited here.

The preset temperature curve is not only related to an aerosol generating substrate, but also to the heating component. During the heating performed by the light-wave infrared heating component on some aerosol generating substrates, the preset temperature curve shown in FIG. 4 is appropriate. The duration of the first stage is usually around 3 seconds. This indicates a very high heating rate. In a case of continuous inhalations performed by a user, the total duration of the second stage and the third stage is about 4 minutes. Due to the impact of infrared radiation, the target temperature is set to continuously decrease in the third stage, which can effectively ensure that the aerosol generating substrate continues to generate aerosols, without producing a burnt smell or peculiar smell, and can provide aerosols that do not change with time and have consistent characteristics.

In some embodiments, the light-wave infrared heating component includes a heating element and a housing. The heating element and the wall portion of the housing are at least partially spaced apart; the surface of the heating element is covered with an infrared radiation layer; the heating element is powered on to excite the infrared radiation layer to radiate infrared light waves; and the wall portion of the housing allows the infrared light waves to pass through.

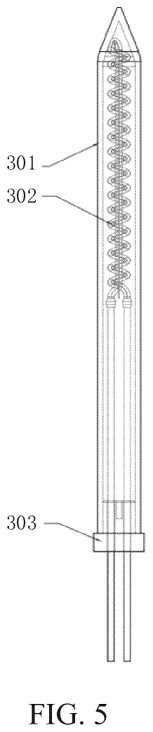

In a preferred embodiment, referring to FIG. 5, a heating element 302 is located inside a housing 301. The housing 301 and the heating element 302 are mounted on a base 303, and the housing 301 is at least partially inserted into an aerosol generating substrate. The heating element 302 and the wall portion of the housing 301 are at least partially spaced apart. The surface of the heating element 302 is covered with an infrared radiation layer. The heating element 302 is powered on to excite the infrared radiation layer to radiate infrared light waves. The heating element 302 radiates the infrared light waves through the housing 301 to heat the aerosol generating substrate located outside the housing 301.

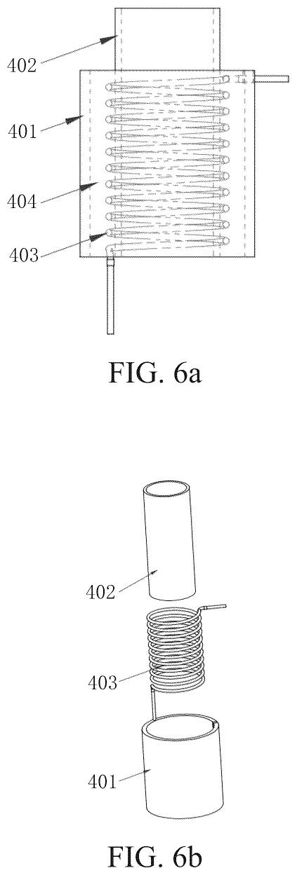

In a preferred embodiment, referring to FIG. 6a and FIG. 6b, the housing includes an outer shell 401 and an inner shell 402. The inner shell 402 is located inside the outer shell 401. A gap is reserved between the outer shell 401 and the inner shell 402. The gap between the outer shell 401 and the inner shell 402 forms a first accommodating cavity. The first accommodating cavity is configured to accommodate a heating element 403. That is, the heating element 403 is located between the outer shell 401 and the inner shell 402, and the heating element 403 surrounds the inner shell 402 by one circle. A second accommodating cavity is formed inside the inner shell 402, and the second accommodating cavity is configured to place an aerosol generating substrate. The heating element 403 is powered on to excite an infrared radiation layer to radiate infrared light waves, and the inner shell 402 allows the infrared light waves to pass through, to heat the aerosol generating substrate. 404 represents a gap between the heating element 403 and the outer shell 401.

The heating element may be of a single-spiral, double-spiral, or N-shaped structure formed by winding a heating wire, or may be barrel-shaped, sheet-like, or columnar. The heating principle is as follows: The heating element mainly relies on the light wave infrared radiation of the infrared radiation layer to heat the aerosol generating substrate. The heat conduction of the heating component assists in heating, which is different from the existing heating component. This light-wave infrared heating manner can make the temperature of the heating component reach 1300° C., generally 500° C. to 1000° C. In a steady-state heating process, 600° C. to 800° C. is preferred (the local temperature of the heating component in the existing art is probably about 420° C. at most). The infrared radiation layer within this temperature range mainly radiates light waves with a wavelength of 2 μm to 14 μm, which is a band range mostly easily absorbed by the aerosol generating substrate. Particularly, within a band range of 2 μm to 5 μm, the energy density is high, and the aerosol generating substrate can be heated quickly.

In some embodiments, the heating component includes a heating base and an infrared radiation layer wrapped around the heating base. The heating base includes a metal base with high-temperature oxidation resistance, for example, a metal wire. The heating base may be a metal material that has good high-temperature oxidation resistance, high stability, difficult deformation, and the like, such as a nichrome base (such as a nichrome wire) and an aludirome base (such as an aludirome wire). In some embodiments, the diameter of the metal wire may be 0.15 mm to 0.8 mm. The metal wire may be bent or wound into various shapes, such as a spiral shape, a mesh shape, an M shape, or an N shape. The bent or wound heating component has a columnar shape, a spiral segment, a mesh shape, or another three-dimensional or planar shape with bends as a whole.

In this embodiment, the heating component further includes an oxidation resistance layer, and the oxidation resistance layer is formed between the heating substrate and the infrared radiation layer. Specifically, the oxidation resistance layer may be an oxide film. The heating base is subjected to high-temperature heat treatment, and a dense oxide film is formed on the surface of the heating base. The oxide film forms the oxidation resistance layer. Certainly, it may be understood that in some other embodiments, the oxidation resistance layer is not limited to including the oxide film formed by itself. In some other embodiments, the oxidation resistance layer may be an oxidation resistance coating applied to the outer surface of the heating base. The thickness of the oxidation resistance layer may be selectively 1 μm to 150 um.

In some embodiments, the infrared radiation layer may be an infrared layer. The infrared layer may be formed on one side of the oxidation resistance layer away from the heating base by an infrared layer forming base through high-temperature heat treatment. Specifically, the infrared layer forming base may be silicon carbide, spinel, or a composite base thereof. Certainly, it may be understood that in some other embodiments, the infrared radiation layer is not limited to being the infrared layer. In some other embodiments, the infrared radiation layer may be a composite infrared layer. Specifically, the infrared layer may be formed on the side of the oxidation resistance layer away from the heating base in a manner of dip coating, spray coating, brush coating, or the like. The thickness of the infrared radiation layer may be 10 μm to 300 um.

It should be noted that the heating manner in this embodiment is not limited to light-wave infrared heating, and is also applicable to other heating manners such as resistance heating, electromagnetic heating, and infrared heating.

At different electric quantities, the power supply outputs different power to heat the heating component within the same preset time t. As a result, after the heating component is heated for the same preset time t, a vaping experience difference may occur. In some embodiments, the first power is the maximum power that can be provided to the heating component under a condition that the voltage of the power supply is a preset voltage, and the preset voltage is a minimum voltage corresponding to an ability of the heat-not-burn device for heating one unit of aerosol generating substrate. One unit is a minimum unit of each heating of the heat-not-burn device, such as a piece of aerosol generating substrate.

Specifically, to improve the consistency of vaping experience, in some embodiments, a constant voltage module is further included. In a case that the control module is the same, the constant voltage module enables the power supply at different voltages to provide the same electrical energy output to the heating component. The same electrical energy output is based on the preset voltage. It should be noted that the constant voltage module can be implemented by a dedicated hardware circuit or through software.

When a power voltage is less than the preset voltage, and the heat-not-burn device receives a start signal of a user, since the power of the heat-not-burn device is not enough to heat one unit (piece) of aerosol generating substrate for a complete inhalation cycle, the heat-not-burn device will not perform a heating operation in response to the start signal. In some embodiments, a prompt response will be made, to prompt the user of low battery and to charge the heat-not-burn device.

In this embodiment of the present disclosure, within the preset time for starting the heating, the power supply heats the heating component at the first power. After the preset time, there are various implementations for controlling, by the control module, the power supplying of the heating component to cause the temperature of the heating component to vary based on the preset temperature curve.

In some embodiments, within the preset time for starting the heating, the power supplying of the heating component is controlled by using the first PID control algorithm, so that the electrical energy supplied to the heating component remains at the first power. In the first PID control algorithm, a deviation value is processed based on a first function to obtain a proportional product factor; the deviation value is a difference between the target temperature of the heating component and a current temperature; the first function is a monotonically increasing function; and a slope of the first function increases as the deviation value increases.

Specifically,

$${OUT}_{k} = Kp \times f ( {E}_{k} ) + K i \sum {E}_{k} + K d \times ( {E}_{k} - {E}_{k - 1} )$$

Where OUTₖ is the current output of the first PID control algorithm; Kp is a proportional term coefficient; f(Eₖ) is a proportional product factor; the deviation value Eₖ is the difference Eₖ=T_{target}−T_{current} between the target temperature T_{target} of the heating component and the current temperature T_{current}; Ki is an integral term coefficient; and Kd is a differential term coefficient.

The first function is one of a cubic function f(Eₖ)=Eₖ³, an exponential function f(Eₖ)=e^{E}^{ₖ}, or a product f(Eₖ)=Eₖ·|Eₖ| of the deviation value and the absolute value of the deviation value.

Under the control of the first PID control algorithm, when a current temperature value is significantly different from a target value, that is, within the preset time range, due to a large output value of the first function, an output value affected by a proportional term is amplified, so that the power supply heats the heating component at the first power within the preset time range. After the preset time, the current temperature value is slightly different from the target value, and the output value of the first function rapidly decreases. The output power of the power supply to the heating component sharply decreases, thus slowing down the temperature rise and preventing an overshooting phenomenon (i.e. an actual temperature is greater than the target temperature). This allows the temperature of the heating component to vary based on the preset temperature curve.

In some embodiments, the constant voltage module is connected after the output of the first PID control algorithm, so that in a case of the same output of the first PID control algorithm, the module enables the power supply at different voltages to provide the same electrical energy output to the heating component.

In some other embodiments, within the preset time for starting the heating, no PID control is involved. The power supply heats the heating component at the first power, that is, the power supply directly supplies power to the heating component, or after being modulated by the constant voltage module, the power supply is connected to the heating component to supply power to the heating component. After the preset time, the power supplying of the heating component is controlled by using a second PID control algorithm; and the second PID control algorithm is an incremental PID control algorithm. The incremental PID control algorithm is more advantageous for the heating component to switch from a non PID control state to a PID control state.

In some embodiments, an initial value of an output value in the second PID control algorithm is an output preset value. The output preset value is based on a maximum value that can be set within the second preset time, without exceeding the target temperature. A larger output preset value can more quickly control the temperature of the heating component at the target temperature.

In still some other embodiments, within the preset time for starting the heating, the power supplying of the heating component is controlled by using a third PID control algorithm, to cause the power supply to heat the heating component at the first power; and in the third PID control algorithm, a target temperature is set based on the power supplied to the heating component reaching the first power within the preset time. By the above manner, it is ensured that the power supplying of the heating component reaches the first power under the control of the third PID control algorithm within the preset time.

After the preset time, the third PID control algorithm adjusts the electrical energy supplied to the heating component based on the target temperature and the actually measured temperature of the heating component, to ensure that the temperature of the heating component reaches the target temperature. The target temperature is obtained based on the preset temperature curve.

An embodiment of the present disclosure further provides a heat-not-burn device control circuit. The control circuit is connected to a heating component during use. The control circuit includes a memory and is configured to implement the steps of the heating control method for the heat-not-burn device.

An embodiment of the present disclosure further provides a heat-not-burn device, including a heating component, a power supply for supplying power to the heating component, a processor, and a memory having a computer program stored therein. The processor, when executing the computer program, implements the steps of the above heating control method for the heat-not-burn device.

An embodiment of the present disclosure further provides a computer storage medium, having a computer program stored therein. The computer program, when executed by a processor, implements the steps of the heating control method for the heat-not-burn device.

The computer-readable storage medium of the present disclosure may be various computer-readable storage media that can store program codes, such as a USB flash disk, a read-only memory (ROM), a magnetic disk, and an optical disc.

The processor of the present disclosure is configured to provide computing and control capabilities to support the operation of the heat-not-burn device. It should be understood that in the embodiments of the present disclosure, the processor may be a central processing unit (CPU), or may be other general-purpose processors, digital signal processors (DSPs), application-specific integrated circuits (ASICs), field-programmable gate arrays (FPGAs), or may be other programmable logic devices, discrete gates or transistor logic devices, and discrete hardware components. The general-purpose processor may be a microprocessor, or the processor may be any conventional processor, or the like.

It should be understood that although the terms “first”, “second”, “third”, and the like may be used herein to describe various elements, components, regions, layers, and/or sections, these elements, components, regions, layers, and/or sections are not to be limited by these terms. These terms can only be used to distinguish one element, component, region, layer, or section from another element, component, region, layer, or section. Therefore, a first element, component, region, layer, or section discussed below may be referred to as a second element, component, region, layer, or section without departing from the teachings of the exemplary embodiments.

As used herein, the term “user experience” means a behavior of consuming an aerosol-forming product. The user experience may include one or more consecutive puffs. The user experience also includes a time period between puffs.

As used herein, the term “and/or” includes any and all combinations of one or more associated listed items.

The aerosol generating substrate may be a solid aerosol generating substrate. Alternatively, the aerosol generating substrate may include solid and liquid components. The aerosol generating substrate may include a tobacco-containing material that contains volatile tobacco aroma compounds released from the substrate upon heating. Alternatively, the aerosol generating substrate may include a non-tobacco material. The aerosol generating substrate may further include an aerosol product. Appropriate examples of the aerosol product are glycerol and propylene glycol.

If the aerosol generating substrate is the solid aerosol generating substrate, the solid aerosol generating substrate may include, for example, one or more of powder, particles, pellets, fragments, strands, strips, or flakes containing one or more of vanilla leaves, tobacco leaves, tobacco stem segments, reconstituted tobaccos, processed tobaccos, homogenized tobaccos, extruded tobaccos, and expanded tobaccos. The solid aerosol generating substrate can be in a loose form or can be placed in an appropriate container or box. For example, an aerosol-forming material of the substrate can be contained inside paper or packaging paper and is in a bar form. In a case that the aerosol generating substrate is in the bar form, the entire bar, including any packaging paper, is considered as the aerosol generating substrate.

Optionally, but not necessarily, the solid aerosol generating substrate may contain additional tobacco or non-tobacco volatile aroma compounds that are released upon the heating of the substrate. The solid aerosol generating substrate may further include capsules. The capsules include, for example, additional tobacco or non-tobacco volatile aroma compounds, and these capsules can be melted during the heating of the solid aerosol generating substrate.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating control method for a heat-not-burn device having a heating component and a power supply for supplying power to the heating component, the heating control method comprising:
heating, by the power supply, the heating component at a first power within a preset time for starting heating; and
after the preset time, controlling the power supplying of the heating component so as to cause a temperature of the heating component to vary based on a preset temperature curve.

2. The heating control method of claim 1, further comprising:
sending a prompt signal at the preset time or within a preset range from the preset time,
wherein the prompt signal is configured to prompt a user to inhale.

3. The heating control method of claim 1, wherein the preset temperature curve comprises:
a first stage of increasing an initial temperature to a first temperature,
a second stage of decreasing the first temperature to a second temperature,
a third stage of maintaining the second temperature, and
a fourth stage of increasing the second temperature.

4. The heating control method of claim 1, wherein the preset temperature curve comprises:
a first stage of increasing an initial temperature to a first temperature, and
a second stage of decreasing the first temperature to a second temperature and maintaining the second temperature.

5. The heating control method of claim 1, wherein the preset temperature curve comprises:
a first stage of increasing an initial temperature to a first temperature,
a second stage of decreasing the first temperature to a second temperature, and
a third stage of being not greater than the second temperature.

6. The heating control method for the heat-not-burn device of claim 3, wherein the heating component is controlled in any heating manner of resistance heating, electromagnetic heating, and infrared heating.

7. The heating control method of claim 6, wherein the heating component is controlled in the heating manner of infrared heating, and
wherein the infrared heating comprises light-wave infrared heating.

8. The heating control method of claim 7, wherein the heating component comprises: a heating element and a housing,
wherein the heating element and a wall portion of the housing are at least partially spaced apart,
wherein a surface of the heating element is covered with an infrared radiation layer,
wherein the heating element is powered on so as to excite the infrared radiation layer to radiate infrared light waves, and
wherein the wall portion of the housing allows the infrared light waves to pass through.

9. The heating control method of claim 8, wherein the heating element is arranged in the housing in a spacing manner, and
wherein the housing is at least partially inserted into an aerosol generating substrate.

10. The heating control method of claim 8, wherein the housing comprises a first tube body and a second tube body sleeving a periphery of the first tube body,
wherein a gap is reserved between the first tube body and the second tube body,
wherein the gap forms a first accommodating cavity configured to accommodate the heating element,
wherein the heating element is arranged at a periphery of the first tube body and is spaced apart from an outer wall of the first tube body, and
wherein a second accommodating cavity configured to heat an aerosol generating substrate is formed on an inner side of the first tube body.

11. The heating control method of claim 1, wherein the first power comprises a maximum power that is provided by the power supply to the heating component, or
wherein the first power is less than a preset range of a maximum power that is provided by the power supply to the heating component.

12. The heating control method of claim 1, wherein the first power comprises a maximum power that is provided to the heating component under a condition that a voltage of the power supply comprises a preset voltage, and
wherein the preset voltage comprises a minimum voltage corresponding to an ability of the heat-not-burn device for heating one unit of aerosol generating substrate.

13. The heating control method of claim 1, wherein, within the preset time for starting the heating, the power supplying of the heating component is controlled using a first proportion-integration-differentiation (PID) control algorithm so as to cause the power supply to heat the heating component at the first power,
wherein, in the first PID control algorithm, a deviation value is processed by using a first function to obtain a proportional product factor,
wherein a deviation value comprises a difference between the target temperature of the heating component and a current temperature,
wherein the first function comprises a monotonically increasing function, and
wherein a slope of the first function increases as the deviation value increases.

14. The heating control method of claim 13, wherein the first function comprises a cubic function, an exponential function, or a product of the deviation value and an absolute value of the deviation value.

15. The heating control method of claim 14, wherein, after the preset time, the power supplying of the heating component is controlled using the first PID control algorithm so as to cause the temperature of the heating component to vary based on the preset temperature curve.

16. The heating control method of claim 1, wherein, within the preset time for initiating the heating, the power supply heats the heating component at the first power,
wherein, after the preset time, the power supplying of the heating component is controlled using a second PID control algorithm, and
wherein the second PID control algorithm comprises an incremental PID control algorithm.

17. The heating control method of claim 16, wherein an initial value of an output value in the second PID control algorithm comprises an output preset value, and
wherein the output preset value comprises a maximum value that is set within a second preset time while not exceeding the target temperature.

18. The heating control method of claim 1, wherein, within the preset time for initiating the heating, the power supplying of the heating component is controlled using a third PID control algorithm so as to cause the power supply to heat the heating component at the first power and
wherein, in the third PID control algorithm, a target temperature is set based on the power supplied to the heating component reaching the first power within the preset time.

19. The heating control method of claim 18, wherein, after the preset time, the power supplying of the heating component is controlled using the third PID control algorithm so as to cause the temperature of the heating component to vary based on the preset temperature curve, and
wherein the target temperature of the heating component in the third PID control algorithm comprises a temperature corresponding to a current moment in the preset temperature curve.

20. A heat-not-burn device, comprising:
a heating component;
a power supply configured to supply power to the heating component;
a processor; and
a memory having a computer program stored in the processor,
wherein the processor, when executing the computer program, implements the method of claim 1.
